(19) United States
(12) Patent Application Publication
(10) Pub. No.: US 2007/0085984 A1
(43) Pub. Date: Apr. 19, 2007

(54) Lithographic projection apparatus, device manufacturing method and device manufactured thereby

(75) Inventors: Vadim Yevgenyevich Banine, Helmond (NL); Vladimir Vitalevitch Ivanov, Moscow (RU); Bastiaan Matthias Mertens, 's-Gravenhage (NL); Johannes Hubertus Josephina Moors, Helmond (NL); Bastiaan Theodoor Wolschrijn, Abcoude (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 11/252,240

(22) Filed: Oct. 18, 2005

(51) Int. Cl. G03B 27/52

(52) U.S. Cl. 355/30; 355/53

(57) ABSTRACT

A lithographic projection apparatus includes a radiation system configured to supply a beam of radiation; a mask table provided with a mask holder for holding a mask; a substrate table provided with a substrate holder for holding a substrate; a projection system configured to image an irradiated portion of the mask onto a target portion of the substrate, wherein the projection system is separated from the substrate table by an intervening space that is at least partially evacuated and is delimited at the location of the projection system by a solid surface from which the employed radiation is directed toward the substrate table; the intervening space contains a hollow tube located between the solid surface and the substrate table and situated around the path of the beam of radiation, the tube being configured such that beam of radiation focused by the projection system onto the substrate table does not intercept a wall of the hollow tube; a flushing system is configure to continually flush the inside of the hollow tube with a flow of gas, wherein the gas is hydrogen, the flow of the gas is opposed to the flow of contaminants from the substrate and/or the hollow tube is in fluid communication with the intervening space.

### BACKGROUND OF THE INVENTION

1. Field of the Invention

The present invention relates to a lithographic projection apparatus, a device manufacturing method and a device manufacture thereby.

2. Description of the Related Art

A lithographic projection apparatus can be used, for example, in the manufacture of integrated circuits (ICs). In such a case, the mask (reticle) may contain a circuit pattern corresponding to an individual layer of the IC, and this pattern can then be imaged onto a target area (die) on a substrate (silicon wafer), which has been coated with a layer of photosensitive material (resist). In general, a single wafer will contain a whole network of adjacent dies, which are successively irradiated through the reticle, one at a time. In one type of lithographic projection apparatus, each die is irradiated by exposing the entire reticle pattern onto the die at once; such an apparatus is commonly referred to as a waferstepper. In an alternative apparatus, which is commonly referred to as a step-and-scan apparatus, each die is irradiated by progressively scanning the reticle pattern under the beam in a given reference direction (the “scanning” direction) while synchronously scanning the wafer table parallel or anti-parallel to this direction; since the projection system will have a magnification factor M (generally <1), the speed v at which the wafer table is scanned will be a factor M times that at which the reticle table is scanned. More information with regard to lithographic devices as here described can be gleaned from U.S. Pat. No. 6,046,792.

Until very recently, apparatus of this type contained a single mask table and a single substrate table. However, machines are now becoming available in which there are at least two independently movable substrate tables; see, for example, the multi-stage apparatus described in U.S. Pat. No. 6,262,796. The basic operating principle behind such multi-stage apparatus is that, while a first substrate table is underneath the projection system so as to allow exposure of a first substrate located on that table, a second substrate table can run to a loading position, discharge an exposed substrate, pick up a new substrate, perform some initial alignment measurements on the new substrate, and then stand by to transfer this new substrate to the exposure position underneath the projection system as soon as exposure of the first substrate is completed, whence the cycle repeats itself; in this manner, it is possible to achieve a substantially increased machine throughput, which in turn improves the cost of ownership of the machine

In currently available lithographic devices, the employed radiation is generally ultra-violet (UV) light, which can be derived from an excimer laser or mercury lamp, for example; many such devices use UV light having a wavelength of 365 nm or 248 nm. However, the rapidly developing electronics industry continually demands lithographic devices which can achieve ever-higher resolutions, and this is forcing the industry toward even shorter-wavelength radiation, particularly UV light with a wavelength of 193 nm or 157 nm. Beyond this point there are several possible scenarios, including the use of in-band extreme UV light (EUV: wavelength ˜50 nm and less, e.g. 13.4 nm, 13.5 nm or 11 nm), X-rays, ion beams or electron beams. All of these so-called next-generation radiations undergo absorption in air, so that it becomes necessary to at least partially evacuate the environment in which they are employed. This introduces considerable problems.

A general discussion of the use of EUV in lithographic projection apparatus can be found, for example, in the article by J. B. Murphy et al. in Applied Optics 32 (24), pp 6920-6929 (1993). Similar discussions with regard to electron-beam lithography can be found in U.S. Pat. No. 5,079,112 and U.S. Pat. No. 5,260,151, as well as in U.S. Pat. No. 6,429,440.

### SUMMARY OF THE INVENTION

It is an aspect of the present invention to provide lithographic projection apparatus including a radiation system configured to supply a beam of radiation; a mask table configured to hold a mask; a substrate table configured to hold a substrate; a projection system configured to image an irradiated portion of the mask onto a target portion of the substrate, which apparatus is compatible for use in a vacuum or semi-vacuum environment. In particular, it is an aspect of the present invention that such an apparatus should be compatible with the use of radiation including EUV, charged particles or X-rays. More specifically, it is an aspect of the invention that such an apparatus should not suffer from significant “down-time” due to decrease of operational performance caused by degeneration of the projection system.

The apparatus to achieve these aspects includes an apparatus as described above including: the projection system is separated from the substrate table by an intervening space that is at least partially evacuated and is delimited at the location of the projection system by a solid surface from which the employed radiation is directed toward the substrate table; the intervening space contains a hollow tube located between the solid surface and the substrate table and situated around the path of the radiation, the tube being configured such that radiation focused by the projection system onto the substrate table does not intercept a wall of the hollow tube; a flushing system is configured to continually flush the inside of the hollow tube with a flow of gas.

This is known as a dynamic gas lock and is described, for example, in U.S. Pat. No. 6,459,472. Further features that improve the apparatus are described below.

The “solid surface” referred to is, for example, the final mirror in the projection system from which the radiation is directed toward the substrate, or a (thin) optical flat (i.e. optical window) included of a vitreous material. The term vitreous should here be interpreted as encompassing such materials as silicates, quartz, various transparent oxides and fluorides (such as magnesium fluoride, for example) and other refractories.

In experiments leading to the present invention, the inventors built a prototype device in which the radiation system delivered EUV (with a wavelength of approx. 13.4 nm). A projection system (including various mirrors) was used to focus the laser radiation onto a substrate table, onto which a test wafer could be mounted. A substantially evacuated enclosure, delimited (bounded) at one end by the exit aperture of the laser and at the other end by the substrate table, was provided around the projection system, so that the path of the radiation from source to substrate was substantially airless, including therefore the intervening space between the projection system and the substrate table. This intervening space was delimited on the side facing the substrate table by the last mirror in the projection system (the “solid surface” referred to hereabove). Such evacuation was done because of the fact that EUV undergoes significant absorption in air, and was aimed at avoiding substantial light-loss at substrate level.

In working with this prototype system, the inventors observed rapid degeneration of the resolution and definition of fine (submicron-sized) images projected onto a resist-coated wafer on the substrate table. Many different possible sources of this problem were sought and investigated before the inventors finally observed that the final optical surface (mirror) in the projection system had become unacceptably contaminated. Further analysis demonstrated that this contamination was caused by the presence of a spurious coating of organic material, which was subsequently identified as consisting of debris and bye-products from the resist layer on the wafer. Evidently, such material was being “sputtered” loose from the wafer by the EUV beam, and the evacuated intervening space between the wafer and the projection system allowed the released material to migrate toward the projection system (and other vicinal surfaces) without undergoing substantial scattering or deflection. Once arrived at the projection system, the material was adsorbed onto the highly accurate optical surfaces of the system, causing the optical surface degradation.

In an effort to combat this problem, the inventors increased the distance between the substrate table and the projection system, but rapid contamination of the final optical surface of the projection system was still observed. Subsequent calculations revealed that such an approach was unsatisfactory, and that a more radical anti-contamination measure was required. Eventually, after trying various other approaches, the inventors arrived at the solution described above. In the inventive solution, the flush of gas prevents resist debris from reaching the projection system in the first place.

The gas employed in the flush should be a substance that does not substantially absorb the radiation in the beam (e.g. EUV), while having a substantially low diffusion coefficient for contaminants. Examples of such gases that have been used in dynamic gas locks are Ar and Kr.

A dynamic gas locks that uses gases such as Ar is described in U.S. Pat. No. 6,198,792, which describes a hole in a membrane, the membrane separating the projection system area from the substrate area, the hole being for allowing the projected radiation to impinge on the substrate. The inert gas flows across the transmission direction of the radiation beam.

A dynamic gas lock which describes a flow going in the same direction as the projected radiation, which further has a membrane or window through which the projected radiation must be transmitted is described in U.S. Pat. No. 6,683,936, U.S. Pat. No. 6,642,996 and U.S. Pat. No. 5,305,364. The hollow tube of these latter documents that directs the inert gas may be cone-shaped and is covered at its top end by a membrane through which the radiation must travel before impinging on the substrate. The membrane prevents the inert gas from flowing upwards towards the projection system.

The problem with having a membrane to prevent upward flow of the inert gas is that the amount of projected radiation going through the membrane is inevitably absorbed or deflected. A typical loss is as much as half of the EUV radiation intensity. A problem with using heavy gases such as Ar is that a greater pressure is required to create a desired flow of heavier gases because of the greater mass to move.

The present invention seeks to prevent the loss of EUV radiation, while providing the effects of a dynamic gas lock.

The apparatus of the present invention includes a hollow tube having the form of a cone, which tapers inwards in a direction extending from the solid surface towards the substrate table. As the projection system serves to focus an image onto the substrate, the radiation emerging from the projection system will taper inwards toward the final image on the wafer. If the employed hollow tube is of a conical form that imitates this tapering, then the tube will have the minimal volume necessary to encapsulate the emergent radiation. This minimizes the flow of gas required to produce an effective flush, leading to materials savings; in addition, the gas load to the system is reduced.

In the apparatus, the gas may be introduced into the hollow tube via at least one opening in a wall of the tube. Alternatively, the gas can, for example, be introduced over a top rim of the tube. In an embodiment, the opening is a region which is porous to the employed gas.

Another embodiment of the apparatus according to the present invention includes a flushing system in which the flush of gas in the hollow tube is at least partially directed towards the substrate table. The very presence of gas at all (whether static or dynamic) between the substrate and the projection system provides a scattering barrier to debris migrating from the substrate. However, if such gas is additionally directed toward the substrate, then this provides an additional safeguard against such debris reaching the projection system. It should be noted that the flush need not be directed in its entirety towards the substrate. For example, if the gas is introduced via an opening in the wall of the tube located at some point (e.g. half way) between its upper and lower limits (rims), then some of the gas can flow from the hole upwards (toward the projection system) and the rest can flow downwards (toward the substrate).

According to another embodiment of the present invention, there is provided a dynamic gas lock as described above, wherein the gas used is hydrogen, heavy hydrogen or deuterium, deuterated hydrogen, or another light gas.

According to still another embodiment of the present invention, there is a dynamic gas lock as described above, with no member separating the intervening space from the space including the hollow tube, and wherein the hollow tube contains a region in which flow of contaminants issuing from the substrate and a flow of the gas are opposed.

According to a further embodiment of the present invention, the solid surface is a reflecting surface and the optic path from this reflecting surface to the target portion of the substrate held in the substrate table traverses only fluid; i.e. there is no member separating the intervening space from the space including the hollow member.

According to a still further embodiment of the present invention, there is device manufacturing method including providing each of the components of the lithographic apparatus and the dynamic gas lock described above, and further including flushing the inside of the hollow tube with a flow of some form of hydrogen.

According to a further embodiment of the invention, the method includes the flow of gas in the region of the hollow tube opposing the flow of contaminant issuing from the substrate and there being no member separating the intervening space from the space including the hollow member.

According to a yet further embodiment of the present invention, there is provided a method as outlined above, wherein the solid surface is a reflecting surface and the optical path between the reflecting surface and the target portion of the substrate held in the substrate table traverses only fluid, i.e. there is no member separating the intervening space from the space including the hollow member.

There is further provided according to another embodiment of the present invention a device manufactured in accordance with any of the above-defined methods.

In a manufacturing process using a lithographic projection apparatus according to the present invention, a pattern in a mask is imaged onto a substrate, which is at least partially covered by a layer of energy-sensitive material (resist). Prior to this imaging, the substrate may undergo various procedures, such as priming, resist coating and a soft bake. After exposure, the substrate may be subjected to other procedures, such as a post-exposure bake (PEB), development, a hard bake and measurement/inspection of the imaged features. This array of procedures is used as a basis to pattern an individual layer of a device, e.g. an IC. Such a patterned layer may then undergo various processes such as etching, ion-implantation (doping), metallization, oxidation, chemo-mechanical polishing, etc., all intended to finish off an individual layer. If several layers are required, then the whole procedure, or a variant thereof, will have to be repeated for each new layer. Eventually, an array of devices will be present on the substrate (wafer). These devices are then separated from one another by a technique such as dicing or sawing, whence the individual devices can be mounted on a carrier, connected to pins, etc. Further information regarding such processes can be obtained, for example, from the book “Microchip Fabrication: A Practical Guide to Semiconductor Processing”, Third Edition, by Peter van Zant, McGraw Hill Publishing Co., 1997, ISBN 0-07-067250-4.

Although specific reference has been made hereabove to the use of the apparatus according to the invention in the manufacture of ICs, it should be explicitly understood that such an apparatus has many other possible applications. For example, it may be employed in the manufacture of integrated optical systems, guidance and detection patterns for magnetic domain memories, liquid-crystal display panels, thin-film magnetic heads, etc. One of ordinary skill in the art will appreciate that, in the context of such alternative applications, any use of the terms “reticle”, “wafer” or “die” in this text should be considered as being replaced by the more general terms “mask”, “substrate” and “target area”, respectively.

Although the discussion in this text concentrates somewhat on the use of EUV, it should be explicitly noted that the present invention is also applicable in systems employing other radiation types. For example, in the case of a lithographic apparatus employing UV light in combination with a (partially) evacuated environment, aimed, for example, at reducing substrate contamination, the present invention combats the built-up of resist debris on the UV projection optics. Similarly, in the case of electron or ion beam lithography, the present invention combats the build-up of substrate-produced contaminants on field-lens electrodes. In all cases, the present invention also combats the migration of debris from the substrate to the mask, radiation source, etc.

### BRIEF DESCRIPTION OF THE DRAWINGS

The invention and its attendant advantages will be further elucidated with the of exemplary Embodiments and the accompanying schematic drawings, whereby:

FIG. 1 renders a schematic view of a lithographic projection apparatus according to the present invention;

FIG. 2 shows a cross-sectional view of part of the apparatus depicted in FIG. 1 and illustrates how the present invention can be used according to embodiments of the present invention.

In the figures, like reference symbols denote corresponding features.

### DETAILED DESCRIPTION

Resist contamination as hereabove described can be divided in two parts: solvents and exposure products. The solvents are necessary for spinning the resist onto the wafer, but after baking for a few hours at temperatures of the order of 160-175° C., for example, they will generally have evaporated. It is not very likely that complete molecules of the resist will evaporate during exposure, because the molecular mass is too high. However, it is possible that parts of the resist molecules evaporate after they have been cracked by the beam during exposure.

When resist is illuminated by energetic radiation, the long chains of resist molecules can interconnect or break depending on the type of resist used: negative or positive resist. In the case of breaking, short chains of organic material will be created, and these may evaporate from the resist. In a vacuum system, these particles can travel through the system freely and reach those optical elements of the projection system which are “visible” from the illuminated wafer, even though the distance between resist and optics can be quite large (e.g. about 0.5 meter). Carbon- and oxide-containing molecules will adsorb relatively easily onto the mirror surfaces.

The mean free path of the contamination molecules is:
λ=(k_{B}T)/(√2pπd²)
where:
k_{B}=Boltzmann constant [1.38×10⁻²³ J/K]
T=temperature of gas [e.g. 300 K]
p=pressure of background gas inside the camera [Pa]
d=effective diameter of a contamination molecule

On average, a debris molecule can reach a surface at 0.5 m without scattering if the environmental pressure is lower than 3×10⁻⁴ mbar. This pressure is equal to, or even higher than, the pressure in an EUV system, so that we may assume that the debris molecules will reach the last projection-system mirror without obstruction. The contamination molecules are assumed to be emitted with a cos(θ) angular distribution. Therefore, at least all molecules that are emitted within a solid angle the same as that of the EUV beam will reach the last mirror. For NA (numeric aperture )=0.1, this fraction of the total yield is:

$$1 / π {\int }_{0}^{2 π} {\int }_{0}^{α} cos ( θ ) sin ( θ ) ⅆ ϑ ⅆ ϕ \approx 1 \%$$

where α is the half opening angle of the EUV beam [NA 0.1→α˜5.5°]. A fraction of these molecules reaching the last mirror will be adsorbed. The result of this adsorption can be a decrease of the mirror's reflectivity and/or a degradation of its surface smoothness, which results in enhanced scattering of the EUV light.

The Total Integrated Scatter (TIS) is of the order of (4πσ/λ²), where σ is the RMS surface roughness and λ the wavelength of the incident light. Allowing a TIS due to surface roughness of the order of 1%, we obtain a maximum acceptable RMS surface roughness of the order of 0.1 nm. In the assumption that 50% of this roughness is due to contamination adsorption, one obtains:
contamination-induced roughness (RMS)=0.05 nm=(ΣΔz²/ N)^{1/2}=√(fΔz²)
where:
Δz: effective thickness of adsorbed contamination
Σ: summation over particles in illuminated footprint on mirror
N: number of monolayer particles in illuminated footprint on mirror
f: fractional monolayer coverage

In the assumption that the diameter of an adsorbed molecule is of the order of 0.25 nm (e.g. 0.23 nm for CO₂) it can be calculated that the maximum allowed fractional monolayer coverage is about 5%. In other words, after deposition of 0.05 monolayer of contamination, the optics do not comply with roughness requirements anymore. This implies a permitted maximum of 10¹⁴ adsorbed debris molecules/cm² inside the EUV footprint of the beam on the last mirror of a projection system (e.g. a “Jewell-type” projection system as described in U.S. Pat. No. 5,063,568).

In order to calculate the time it takes before the maximum allowed debris layer is deposited onto the exposed mirror, one has to know the flux of debris due to the 13.4 m bombardment. The photodesorption yield of neutrals emitted after irradiation by EUV with λ=13.4 nm EUV (92.7 eV) or 11 nm (109 eV) can be estimated from measurements of the yield after impact of 4.9 eV photons (254 nm radiation) or 25 eV electrons [see G. Hiraoka, IBM Journal of Research and Development, 1977, pp 121-130]. This is done assuming that the yield over this small energy range scales purely with excitation energy and is independent of the type of excitation [G. D. Kubiak et al., J. Vac. Sci. Technol. B 10(6), 1992, pp 2593-2599]. From the data presented in Table 1 (obtained from the above-mentioned Hiraoka article) we infer that, for PMMA resist, of the order of one hydrocarbon molecule (disregarding the CO₂ production) is released per incident photon of 100 eV. If we assume a PMMA sensitivity to 13.4-nm radiation of 75 mJ/cm², we find from the tabulated data that the total photodesorption yield per exposure with EUV radiation is of the order of 5×10¹⁵ molecules/cm for PMMA. For AZ.PN 114 resist, this should be two orders of magnitude less. Dedicated EUV resists are being developed by several manufacturers. Outgassing to some degree is expected.

If 40% of the area of a 300 mm wafer is exposed, the produced hydrocarbon amount is of the order of 10¹⁸ molecules/wafer for PMMA and 10¹⁶ molecules/wafer for AZ.PN 114. Above, it has already been shown that 1% of these hydrocarbon molecules retraces the optical path and coats the last mirror. The footprint on the last mirror is ˜100² cm, which implies that, per illuminated wafer using PMMA resist, 10¹⁴ debris molecules/cm² will hit the exposed mirror. In other words, assuming all molecules stick, after exposure of only one wafer the debris coverage of the last mirror already exceeds the maximum allowed value.

TABLE 1
Contamination from PMMA resist due to
radiation and electron bombardment

| | Quantum efficiency | Yield for 25-eV |
|---|---|---|
| | (%) of UV photolysis | electron beam |
| | at 254 nm and | exposure |
| Product | T = 297 K | [molec./100 eV] |
| CH₃•+CH₄ | 0.8 | not measured |
| CO | 0.7 | not measured |
| CHO | not measured | not measured |
| CH₃O•+CH₃OH | 0.9 | 0.01 |
| CH₃CH═CH₂ | none | 0.08 |
| CO₂ | 0.8 | 0.18 |
| (CH3)₂C═CH₂ | none | 0.08 |
| HCOOCH₃ | none | 0.004 |
| (CH₃)₂CHCO₂CH₃ | none | 0.02 |
| (CH₃)₃C0₂CH₃ | none | 0.01 |
| CH₃C(═CH₂)CO₂CH₃ | not measured | 0.22 |
| Mⁿ/Mⁿₒ * | not measured | 0.79 |

* Monomeric compounds such as methyl methacrylate, methyl pivalate, and methyl isobutyrate.

Although the above calculation is only a rough approximation, it is clear that the demonstrated contamination cannot be tolerated. Therefore it is important to find methods to increase the lifetime of the optical elements.

Table 2 relates to the use of a gas flush according to the invention, and shows calculated pressure distributions and contamination distributions for various amounts and positions of gas introduction. The background pressure is 2.5 Pa. The gas loads are given per steradian; therefore, the actual gas load on the system is 2π larger.

TABLE 2
Suppression of debris due to gas flow in tube.

| | | Suppression factor |
|---|---|---|
| Gas load | Introduction height | of debris (fraction |
| [mbar · l/s] | above wafer [cm] | debris in buffer gas) |
| 3.17 | 3 | 10⁻⁸ |
| 5.34 | 3 | <10⁻¹² |
| 6.97 | 3 | <10⁻¹² |
| 3.25 | 6 | <10⁻⁴ |
| 5.65 | 6 | 10⁻⁸ |
| 6.98 | 6 | 10⁻¹⁰ |

The above figures were obtained using Computer Fluid Dynamics calculations. The lowest background pressure in these calculations to ensure reliable results is 2.5 Pa. However, in an actual system the pressure may be lower.

The efficiency and the gas path both increase with increasing height of gas introduction above the wafer, for constant gas pressure at the entrance position. This is because, in general, only gas flowing toward the wafer is sufficiently effective in preventing debris from entering the (vacuum) enclosure in which the projection system is located, and such prevention occurs over a larger distance when the gas is introduced at a higher position. The change of absorption resulting from the change of gas path is not very significant. The absorption is less than 10% for all but the highest introduction points.

A reasonable result is achieved for 35 Pa gas pressure at an introduction point which is about 50 mm above the wafer, corresponding to 30 mm into the tube, since a final distance between the wafer and the bottom of the tube of 20 mm is assumed. At that working point, a debris suppression efficiency of 10¹¹ is possible (increasing the average time-lapse between having to clean the optics by four orders of magnitude, or more) with only 9% EUV light absorption.

Generally, for the same absorption of EUV, the stopping efficiency of both H₂ and Ar are comparable. However, the configuration of the complete system does not allow sufficient pressure of heavy gases such as Ar throughout the system. Lighter gases such as H₂, D, HD and He do not pose such a problem. This is because a larger amount of lighter gas can be pumped through the same opening in a molecular regime than a heavier gas. Molecule velocities are directly proportional to the square root of the mass of the molecules. In other words, H₂, D, HD and He are easier to pump at the acceptable pressure level for the system.

According to the above-mentioned state of the art, it would not have been obvious to use lighter elements such as hydrogen or helium because heavier gases are more likely to firstly flow in the correct direction and secondly intercept the contamination molecules that are being issued from the substrate.

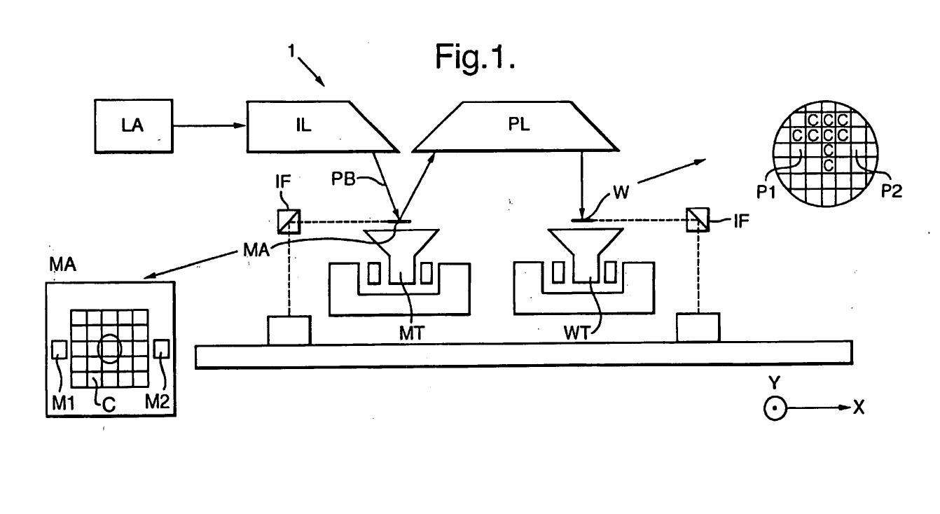

FIG. 1 renders a schematic perspective view of a lithographic projection apparatus suitable for use with the present invention. The apparatus includes a radiation system LA, IL configured to supply a beam PB of radiation (e.g. EUV light with a wavelength in the range 10-15 nm, or a flux of electrons, ions or X-rays); a mask table MT, configured to hold and position a mask MA (e.g. a reticle); a substrate table WT configured to hold and position a substrate W (e.g. a resist-coated silicon wafer); a projection system PL (e.g. a reflective system (mirror group) or a field lens) configured to image an irradiated portion of the mask MA onto a target portion C (die) of the substrate W.

The radiation system includes a source LA (e.g. a synchrotron, undulator or laser, or a charged particle or X-ray source) which produces radiation. The radiation is passed through the beam shaping system IL, so that the resultant beam PB is substantially collimated and uniformly intense throughout its cross-section.

The beam PB subsequently intercepts the mask MA which is held in a mask holder on a mask table MT. From the mask MA, the beam PB passes through the projection system PL, which focuses the beam PB onto a target area C of the substrate W. With the of the interferometric displacement and measuring system IF, the substrate table WT can be moved accurately, e.g. so as to position different target areas C in the path of the beam PB.

The depicted apparatus can be used in two different modes:
1. In step mode, the mask table MT is fixed, and an entire mask image is projected at once (i.e. a single “flash”) onto a target area C. The substrate table WT is then shifted in the x and/or y directions so that a different target area C can be irradiated by the (stationary) beam PB;
2. In scan mode, essentially the same scenario applies, except that a given target area C is not exposed in a single “flash”. Instead, the mask table MT is movable in a given direction (the “scan direction”, e.g. the x direction) with a speed v, so that the beam PB is caused to scan over a mask image; concurrently, the substrate table WT is simultaneously moved in the same or opposite direction at a speed V=Mv, in which M is the magnification of the projection system PL (e.g. M=¼ or ⅕). In this manner, a relatively large target area C can be exposed, without having to compromise on resolution.

Although only one substrate table WT is depicted in FIG. 1, there may at least one other substrate table, which moves in the same plane as the first substrate table WT.

If the beam PB includes radiation such as EUV, charged particles or X-rays, it will generally be necessary to at least partially evacuate the depicted apparatus, at least along the path of the beam PB from the source LA to the wafer W. Such evacuation has the disadvantage that it allows the migration of resist debris from the wafer W over relatively long distances, and particularly into the projection system PL, whence such debris can accumulate on optical surfaces (e.g. mirrors) and cause serious degradation of their quality.

It is known to provide a window or translucent membrane to separate the substrate from the optical surfaces of the projection system in order to prevent debris from accumulating on those optical surfaces. However, debris accumulates on the membrane instead; and the radiation is attenuated by the same membrane, so the problem is not really solved in this way.

This problem can be tackled using the present invention, for example as described in the following embodiments.

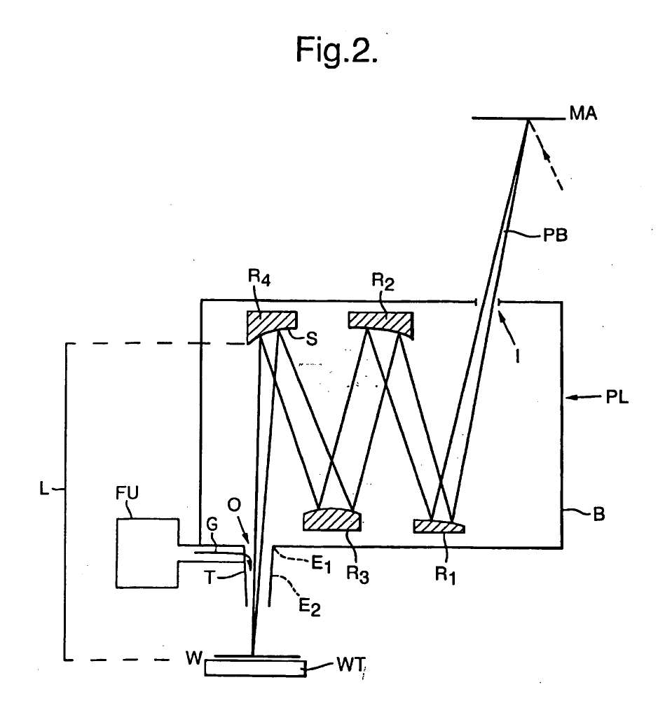

FIG. 2 shows part of an apparatus as depicted in FIG. 1, and demonstrates how the present invention can be applied therein.

The beam PB coming (e.g. reflected) from the mask MA passes through the projection system PL before impinging on the substrate W located on the substrate table WT. In this case, the projection system PL includes four reflectors (mirrors) R₁, R₂, R₃, R₄, which serve to focus the beam PB according to given specifications. In this particular instance, the projection system PL is located in an enclosure B, which is provided with an entrance aperture I and an exit aperture O to allow entrance and exit of the beam PB. Although the presence of the enclosure B helps to prevent the accumulation of resist debris on the surfaces of the mirrors R₁-R₄, it is still possible for reduced quantities of such debris to reach these mirrors, e.g. via the aperture O. There is, however, no membrane or window covering the aperture O. Although a membrane or window might prevent debris from the substrate going up in to the enclosure B, a membrane attenuates large amounts of the projected beam, which would give a further potential area for error in the beam intensity and also require a greater starting intensity for the light source supplying the radiation beam. Furthermore, the membrane or window would accumulate debris itself, reducing its transparency to the radiation beam.

The projection system PL is separated from the substrate table WT by an intervening space L. This space L is delimited at the location of the projection system PL by the solid reflecting surface S of the “final” mirror R₄ in the system PL. It is noted that it is from the mirror R₄ that radiation is finally directed toward the substrate W.

The space L contains a hollow tube T, which is positioned around the path of the radiation beam PB on its way from the surface S to the substrate table WT. This tube T is thus formed, sized and positioned so that its walls do not intercept the beam PB. In this particular case, the tube T is embodied as a continuation of the enclosure B, projecting outward from the exit aperture O. Moreover, as here depicted, the tube T tapers in the direction of the substrate table WT.

According to the invention, the tube T contains a gas which does not substantially absorb EUV, e.g. H₂, He, Ar or Kr. Preferably, this gas is flushed through the tube T in the direction of the substrate W. This can be achieved, for example, by introducing a downward flow of the gas into the tube T in proximity to its top rim E₁ or at some point E₂ between its top and bottom rims; in the case of introduction at such a latter intermediate point E₂, part of the flow may be downward and part may be upward, for example. The advantage of using smaller molecules like H₂ is that the gas is more likely to fit through the porous opening through which the gas is to be introduced into the hollow tube.

The hollow tube is in fluidic communication with space B. This is in order to allow the radiation beam PB to reach the substrate without being attenuated by an extra window or membrane at the top end of the hollow tube. This allows greater accuracy in the final intensity of the beam PB. However, the inert gas G may be angled in such a way as to ensure that the inert gas flows in a direction which is most suitable for eliminating contamination of the projection system (e.g. R₄) by contaminants from the substrate surface W. At least a region of the inert gas flow therefore flows in the opposite direction to the flow of the contaminants from the substrate surface, i.e. downwards towards the substrate surface W. For example, rifling may be used in the tube, forcing the gas flow downwards and therefore the contaminant flow outwards away from the hollow tube.

A further effect of using a light molecule rather than Ar, for instance, is that it reacts more favorably to being ionized by the EUV radiation (or other radiation used). Ar will etch mirror surfaces and decrease the mirror lifetime, whereas He, HD, D and H₂ etch very little if at all because the molecule size is smaller.

Furthermore, an effect of using H₂ or its isotopes is that it can form hydrogen radicals or active H₂ molecules or other active species when illuminated by EUV radiation (for example), which can counteract hydrocarbon or Sn contamination in situ by reacting with the contaminants and carrying them along in the gas flow.

What is claimed is:

1. A lithographic projection apparatus, comprising:
a radiation system configured to supply a beam of radiation;
a mask table configured to hold a mask;
a substrate table configured to hold a substrate; and
a projection system configured to image an irradiated portion of the mask onto a target portion of the substrate, wherein the projection system is separated from the substrate table by an intervening space that is at least partially evacuated and is delimited at the location of the projection system by a solid surface from which the employed radiation is directed toward the substrate table; the intervening space contains a hollow tube located between the solid surface and the substrate table and situated around the path of the beam of radiation, the tube being configured such that beam of radiation focused by the projection system onto the substrate table does not intercept a wall of the hollow tube; a flushing system is configured to continually flush the inside of the hollow tube with a flow of a gas; and the gas is hydrogen.

2. A lithographic projection apparatus, comprising:
a radiation system configured to supply a beam of radiation;
a mask table configured to hold a mask;
a substrate table configured to hold a substrate; and
a projection system configured to image an irradiated portion of the mask onto a target portion of the substrate, wherein the projection system is separated from the substrate table by an intervening space that is at least partially evacuated and is delimited at the location of the projection system by a solid surface from which the employed beam of radiation is directed toward the substrate table; the intervening space contains a hollow tube located between the solid surface and the substrate table and situated around the path of the beam of radiation, the tube being configured such that beam of radiation focused by the projection system onto the substrate table does not intercept a wall of the hollow tube; a flushing system is configured to continually flush the inside of the hollow tube with a flow of a gas; and the gas is deuterium or heavy hydrogen.

3. A lithographic projection apparatus, comprising:
a radiation system configured to supply a beam of radiation;
a mask table configured to hold a mask;
a substrate table configured to hold a substrate; and
a projection system configured to image an irradiated portion of the mask onto a target portion of the substrate, wherein the projection system is separated from the substrate table by an intervening space that is at least partially evacuated and is delimited at the location of the projection system by a solid surface from which the employed radiation is directed toward the substrate table; the intervening space contains a hollow tube located between the solid surface and the substrate table and situated around the path of the beam of radiation, the tube being configured such that beam of radiation focused by the projection system onto the substrate table does not intercept a wall of the hollow tube; a flushing system is configured to continually flush the inside of the hollow tube with a flow of a gas; and the gas is deuterated hydrogen.

4. A lithographic projection apparatus, comprising:
a radiation system configured to supply a beam of radiation;
a mask table configured to hold a mask;
a substrate table configured to hold a substrate; and
a projection system configured to image an irradiated portion of the mask onto a target portion of the substrate, wherein the projection system is separated from the substrate table by an intervening space that is at least partially evacuated and is delimited at the location of the projection system by a solid surface from which the employed radiation is directed toward the substrate table; the intervening space contains a hollow tube located between the solid surface and the substrate table and situated around the path of the beam of radiation, the tube being configured such that the beam of radiation focused by the projection system onto the substrate table does not intercept a wall of the hollow tube; a flushing system is configured to continually flush the inside of the hollow tube with a flow of a gas; and the gas is a light gas.

5. A lithographic projection apparatus, comprising:
a radiation system configured to supply a beam of radiation;
a mask table configured to hold a mask;
a substrate table configured to hold a substrate; and
a projection system configured to image an irradiated portion of the mask onto a target portion of the substrate, wherein the projection system is separated from the substrate table by an intervening space that is at least partially evacuated and is delimited at the location of the projection system by a solid surface from which the beam of radiation is directed toward the substrate table; the intervening space contains a hollow tube located between the solid surface and the substrate table and situated around the path of the beam of radiation, the tube being configured such that radiation focused by the projection system onto the substrate table does not intercept a wall of the hollow tube; there is no member separating the intervening space from the space including the hollow tube; a flushing system is configured to continually flush the inside of the hollow tube with a flow of a gas, wherein the hollow tube contains a region in which a flow of contaminants issuing from the substrate and a flow of the gas are opposed.

6. A lithographic projection apparatus, comprising:
a radiation system configured to supply a beam of radiation;
a mask table configured to hold a mask;
a substrate table configured to hold a substrate; and
a projection system configured to image an irradiated portion of the mask onto a target portion of the substrate, wherein the projection system is separated from the substrate table by an intervening space that is at least partially evacuated and is delimited at the location of the projection system by a solid surface from which the employed radiation is directed toward the substrate table; the intervening space contains a hollow tube located between the solid surface and the substrate table and situated around the path of the beam of radiation, the tube being configured such that beam of radiation focused by the projection system onto the substrate table does not intercept a wall of the hollow tube; a flushing is configured to continually flush the inside of the hollow tube with a flow of a gas; the solid surface is a reflecting surface and the optical path from the reflecting surface to the target portion of the substrate held by the substrate table traverses only fluid.

7. A device manufacturing method, comprising:
providing a beam of radiation;
patterning the beam of radiation;
projecting at least part of the patterned beam of radiation onto a target area of a layer of radiation-sensitive material at least partially covering a substrate supported by a substrate table using a projection system;
separating the projection system from the substrate table by an intervening space that is at least partially evacuated and is delimited at the location of the projection system by a solid surface from which the beam of radiation is directed toward the substrate table;
providing the intervening space with a hollow tube located between the solid surface and the substrate table and situated around the path of the beam of radiation, the tube being configured such that beam of radiation focused by the projection system onto the substrate table does not intercept a wall of the hollow tube; and
continually flushing the inside of the hollow tube with a flow of a gas, wherein the gas is hydrogen.

8. A device manufacturing method, comprising:
providing a beam of radiation;
patterning the beam of radiation;
projecting at least part of the patterned beam of radiation onto a target area of a layer of radiation-sensitive material at least partially covering a substrate supported by a substrate table using a projection system;
separating the projection system from the substrate table by an intervening space that is at least partially evacuated and is delimited at the location of the projection system by a solid surface from which the beam of radiation is directed toward the substrate table;
providing the intervening space with a hollow tube located between the solid surface and the substrate table and situated around the path of the beam of radiation, the tube being configured such that beam of radiation focused by the projection system onto the substrate table does not intercept a wall of the hollow tube; and
continually flushing the inside of the hollow tube with a flow of a gas, wherein the flow of gas in a region of the hollow tube opposes the flow of contaminants issuing from the substrate and there is no member separating the intervening space from the space including the hollow member.

9. A device manufacturing method, comprising:
providing a beam of radiation;
patterning the beam of radiation;
projecting at least part of the patterned beam of radiation onto a target area of a layer of radiation-sensitive material at least partially covering a substrate supported by a substrate table using a projection system;
separating the projection system from the substrate table by an intervening space that is at least partially evacuated and is delimited at the location of the projection system by a solid surface from which the beam of radiation is directed toward the substrate table;
providing the intervening space with a hollow tube located between the solid surface and the substrate table and situated around the path of the beam of radiation, the tube being configured such that beam of radiation focused by the projection system onto the substrate table does not intercept a wall of the hollow tube; and
continually flushing the inside of the hollow tube with a flow of a gas, wherein the solid surface is a reflecting surface and the optical path between the reflecting surface and the target portion of the substrate held by the substrate table traverses only fluid.

10. A device manufactured in accordance with the method of claim 7.

11. A device manufactured in accordance with the method of claim 8.

12. A device manufactured in accordance with the method of claim 9.
